(19) United States
(12) Patent Application Publication
(10) Pub. No.: US 2021/0230518 A1
(43) Pub. Date: Jul. 29, 2021

(54) Cleaning Composition

(71) Applicant: Milliken & Company, Spartanburg, SC (US)

(72) Inventors: Randy D. Petrea, Boiling Springs, SC (US); Laurent D. Kieken, Greenville, SC (US); Shirley A. Whiteside, Chesnee, SC (US)

(21) Appl. No.: 17/232,200

(22) Filed: Apr. 16, 2021

Related U.S. Application Data
(63) Continuation of application No. 14/937,914, filed on Nov. 11, 2015, now abandoned.
(60) Provisional application No. 62/083,970, filed on Nov. 25, 2014.

(51) Int. Cl. C11D 3/39; C11D 3/20; C11D 3/22; C11D 17/00; C11D 7/26; C11D 3/37

(52) U.S. Cl. CPC C11D 3/3942; C11D 3/2065; C11D 3/2082; C11D 3/221; C11D 17/0073; C11D 3/48; C11D 3/3707; C11D 7/265; C11D 3/2086; C11D 3/222; C11D 3/2075; C11D 7/268

(57) ABSTRACT

This invention relates to cleaning compositions with controlled dissolution and improved chelation system. The cleaning composition is generally comprised of a majority by weight of a percarbonate compound, a chelation system, and a binder system. The invention also relates to non-oxidizing solid cleaning compositions containing peroxide moieties. These compositions are ideal for use in cleaning appliances, such as automatic washing machines and dishwashers.

### CROSS REFERENCE TO RELATED APPLICATIONS

This application is a continuation of and claims priority to U.S. application Ser. No. 14/937,914, entitled “Cleaning Composition” which was filed on Nov. 11, 2015, which claims priority to U.S. Provisional Patent Application No. 62/083,970, entitled “Cleaning Composition” which was filed on Nov. 25, 2014, both of which are entirely incorporated by reference herein.

### TECHNICAL FIELD

This invention relates to cleaning compositions with controlled dissolution and improved chelation system. The cleaning composition is generally comprised of a majority by weight of a percarbonate compound, a chelation system, and a binder system. The invention also relates to non-oxidizing solid cleaning compositions containing peroxide moieties. These compositions are ideal for use in cleaning appliances, such as automatic washing machines and dishwashers.

### BACKGROUND

It has been well established in the literature that cleaning appliances, such as automatic washing machines and dishwashers, is necessary under certain circumstances. For example, undesirable odors and/or visible mold and mildew is known to develop over time in the moist environment of such appliances. Some appliances, such as automatic washing machines, have even been developed to possess a cleaning cycle that is specific for cleaning the machine itself.

Many different types of cleaning compositions have been developed for use in preventing and controlling the growth of microbes. These include, for example, bleach compositions and detergent formulations that include bleach compositions. However, with the continual introduction of new consumer products, there exists a constant demand in the marketplace for protection against bacterial and fungal growth presented by some of these new products. Of particular concern, the present invention is directed toward reducing and/or eliminating the growth of microbes and biofilm in home appliances and/or equipment that have water contact surfaces. Examples of home appliances having water contact surfaces include washing machines, dishwashing machines, coffee machines and the like. Other equipment having water contact surfaces include whirlpool-type bathtubs, in-home humidifiers and de-humidifiers, air conditioning units, and the like.

The growth and proliferation of microbes in a washing machine, for instance, generally occurs from prolonged exposure to warm, moist environment which may contain soap residue and clothing residue, such as body oils, fiber particles, and dirt and bacteria from the clothing. This environment leads to the development of undesirable odors and biofilm. Biofilm is the growth of microbes, such as bacteria and fungi, on a surface. Biofilms are commonly surrounded by an exopolymeric matrix. Both the abundant microbial growth and matrix production result in visible microbial communities, thus damaging the aesthetic appeal of the surface. Additionally, secondary metabolites produced as a result of microbial growth include volatile organic compounds (VOCs) that can be detected by the consumer as foul odors.

Front loading laundry machines, in particular, provide an ideal environment for microbial growth in any of the water-contact locations in the machine. The four major components of the machine are generally the wash tub, stainless steel wash cylinder, aluminum support bracket and the circular door sealing gasket (also known as a “bellow”) which provides a seal between the wash compartment and the door of the washing machine. Biofilms may form on the washing machine bellow, on the piping and tubing, which connect the parts and carries the water to and from the machine, on the inner surface of the outer wash tub and on the outer surface of the inner wash tub. As the microbes in the biofilm grow, they tend to penetrate the supporting surface resulting in staining of the surface to which the microbes attach. Microbial growth further leads to degradation of the machine parts which potentially results in reduced life cycle of the parts or the entire laundry machine. Additionally, in the process of biofilm growth and maturation, portions of the biofilm may detach and come into contact with clothing, towels, sheets, etc. that are laundered in the washing machine. This biofilm-to-clothing contact may undesirably and irreversibly stain and leave a residual odor on the clothing that comes into contact with the detached biofilm during the laundering process.

Both top loading and front loading washing machines experience foul odors (both in the machine and transferred to the clothes) as well as mold and staining issues. These problems are thought to originate from biofilm formation on components comprising the washers. The staining on the rubber door bellow is often visible to the consumer after several months. Foul odors caused by the biofilm in other areas of the machine are often noticeable within three months of field use. In worst case scenarios, the odor from the machine is transferred to the clothing.

This problem of microbial growth and proliferation in appliances and equipment having water contact surfaces, particularly in washing machines, has been manifested, in part, by the desire to manufacture more energy efficient and environmentally friendly consumer products. For instance, the laundry care industry is producing high efficiency washing machines designed to clean clothing at lower wash water temperatures. Regulations restricting water volumes in such appliances and the use of excessive liquid laundry detergents have been mandated in some countries. Thus, increased production of front loading washing machines and machines designed to clean clothing at lower temperatures and lower water volumes has created a need for cleaning compositions capable of reducing and/or eliminating microbial growth on water contact surfaces contained within these machines.

One remedy to this problem that is provided by washing machine manufacturers is to include a cleaning cycle as part of the standard offering on the machine cycle dial. Thus, the user care guide and machine cycle dial recommends to machine owners that they should run a periodic cleaning cycle on the machine using a large amount of bleach. In some washing machine models, such as the high efficiency front loading machine, an indicator maintenance light is built into the machine. The light is designed to turn on at regular time intervals (e.g. every 30 days, every six months, etc.) as a reminder to the consumer that it is time to run a cleaning cycle in the machine.

In one example, the high efficiency Whirlpool Duet washer, model no. WFW9400ST00, used in the cleaning test of this disclosure has a dedicated, pre-programmed cleaning cycle, which lasts about 46 minutes and comprises about 6 minutes of preparation, about 20 minutes of cleaning and about 20 minutes of water rinse. In the preparation phase, the washer is partially filled with water, spins a little, and then pumps out all the water. The cleaning phase then starts with a fresh water addition. If the cleaning composition dissolves too quickly, that is the majority of the composition is dissolved in the preparation phase, the latter will be pumped out at the end of the preparation cycle and the cleaning performance will suffer. If the cleaning composition dissolves too slowly, that is the majority of the cleaning composition remains as solids at the end of the cleaning phase, the cleaning performance will suffer as well. Furthermore, if the cleaning composition is in a tablet form, the dissolution speed is slower than in a powder form. Hence, the problem of slow dissolution is exacerbated as pieces of undissolved tablet may be present in the entire cleaning cycle and may damage the inside of the washer as the washer drum spins.

Thus, since washing machines are currently being designed to have a cleaning cycle built in for use by the consumer in preventing/removing microbial growth, the need exists for chemical compositions which may be added to the machine for use during this cleaning cycle. Attempts by others to create cleaning compositions for use in appliances and equipment have included bleach or bleach-containing compositions and other peroxide-based compositions which, as will be shown by example herein, fail to adequately clean and remove microbes, biofilm and any other buildup from the interior of machines having water contact surfaces. Furthermore, the use of bleach or bleach-containing products (e.g. chlorine bleach products) often leads to corrosion problems on various parts within the machine.

Additionally, in some geographical areas of the world, water used in cleaning appliances is “hard”, that is, it contains high amounts of Ca²⁺ and/or Mg²⁺ ions. Hard water can form deposits on internal surfaces of appliances and clog plumbing. These deposits typically are comprised of calcium carbonate, calcium sulfate and/or magnesium hydroxide. Current commercial washer cleaning products such as Affresh® cause a precipitate to form in hard water which may deposit inside the washing machine. This is undesirable and negatively affects the cleaning performance.

The present disclosure addresses and overcomes the problems described above. The cleaning composition having controlled dissolution, an improved chelation system, and improved cleaning performance is generally comprised of a majority by weight of a percarbonate compound. The improved chelation system includes at least one carboxylic acid. The composition does not have a negative effect on the machine parts, clothes, tableware, septic/sewer system, etc. Additionally, the composition has been designed to work with the machine cycle conditions (time, temperature, water volume, etc.) and to reduce or eliminate both the biological and the abiotic build up. For these reasons and others that will be described herein, the present cleaning composition having an improved chelation system and exhibiting improved cleaning performance represents a useful advance over the prior art.

Current commercial products have limitations such as inadequate dissolution wherein solid residue remains in the appliance after a cleaning cycle has been completed. Additionally, cleaning solid ingredients containing peroxide moieties such as sodium percarbonate, sodium perborate monohydrate, sodium persulfate or others are Class 5, Division 5.1 solid oxidizers according to the US Department of Transportation classification and may be unstable over long periods of storage. To prevent the cleaning formulation itself from being a solid oxidizer, the level of the peroxide containing ingredient that can be used in the formulation may be limited, which may negatively impact the cleaning performance.

Therefore, the need exists for continued advancement in the technology of cleaning compositions for use by consumers to address these types of problems.

### BRIEF SUMMARY

In one aspect, the invention relates to a composition comprising a majority by weight of a percarbonate-based compound, a chelation system, wherein the chelation system is comprised of at least one carboxylic acid compound, and a binder system, wherein the binder system is comprised of at least one polyol and a second binder component.

In another aspect, the invention relates to a composition consisting essentially of a majority by weight of a percarbonate-based compound, a chelation system, wherein the chelation system is comprised of at least one carboxylic acid compound, a binder system, wherein the binder system is comprised of at least one polyol and a second binder component, and optionally, at least one lubricating agent.

In a further aspect, the invention relates to a method for cleaning an automatic washing machine comprising the sequential steps of: (a) providing an automatic washing machine having a wash tub; (b) adding a sufficient amount of a cleaning composition to the wash tub, wherein the cleaning composition comprises: (i) a majority by weight of a percarbonate-based compound; (ii) a chelation system, wherein the chelation system is comprised of at least one carboxylic acid compound; and (iii) a binding system, wherein the binding system is comprised of at least one polyol and a second binder component; (c) adding a sufficient amount of water to the wash tub to allow the cleaning composition to dissolve and form a mixture of water and cleaning composition; (d) agitating the mixture of step “c”; (e) removing the mixture of step “c” from the wash tub; and (f) rinsing the wash tub.

In yet another aspect, this invention relates to a non-oxidizer solid cleaning composition comprising: a majority by weight of a percarbonate-based compound; a binder system, wherein the binder system is comprised of at least one polyol and a second binder component; a flame retardant system; and a carboxylic acid compound.

In a further aspect, this invention relates to a method for cleaning an automatic washing machine comprising the sequential steps of: (a) providing an automatic washing machine having a wash tub; (b) adding a sufficient amount of a cleaning composition to the wash tub, wherein the cleaning composition comprises: (i) a majority by weight of a percarbonate-based compound, (ii) a binder system, wherein the binder system is comprised of at least one polyol and a second binder component, (iii) a flame retardant system, and (iv) a carboxylic acid compound; (c) adding a sufficient amount of water to the wash tub to allow the cleaning composition to dissolve and form a mixture of water and cleaning composition; (d) agitating the mixture of step “c”; (e) removing the mixture of step “c” from the wash tub; and (f) rinsing the wash tub.

### BRIEF DESCRIPTION OF THE DRAWINGS

FIG. 1 is a diagram illustrating the relationship between burn time and Class 5 Division 5.1 Solid Oxidizer classification.

FIG. 2 is a chart illustrating the relationship between the weight of tablet residue and the concentration of tartaric acid, Na₂SO₄ and MgSO₄.

### DETAILED DESCRIPTION

All U.S. and foreign patents and U.S. patent applications disclosed in this specification are hereby incorporated by reference in their entirety.

The cleaning composition is generally comprised of a majority by weight of a percarbonate-based compound. Percarbonate-based compounds include, for example, sodium percarbonate compounds. Sodium percarbonate is also known by other names such as sodium carbonate peroxyhydrate and sodium carbonate peroxide. One commercially available percarbonate-based product suitable for the cleaning composition of the present invention is FB® 400 sodium percarbonate available from Solvay Chemicals. This product is a free flowing white granular powder and has an average particle size of 400-550 microns. This product also contains an available active oxygen content equivalent to 27.5% hydrogen peroxide.

The percarbonate-based compound may be present in the range from 1% to 95% by weight of the total composition, or in the range from 10% to 95% by weight, or in the range from 30% to 95% by weight. In another aspect, the percarbonate-based compound may be present in the range from 50% to 70% by weight of the total composition.

The cleaning composition of the present invention includes an improved chelation system. Chelation is generally known as the chemical interaction that involves complexing metal ions to compounds in a chemical composition, mixture, solution, or the like. Metal ions include, for example calcium ions, magnesium ions, and the like. Binding metal ions to the chelating compound tends to keep the ions in solution, rather than allowing them to form precipitates and settle to the bottom of a liquid solution. Examples of chelators include trisodium phosphate, ethylenediaminetriacetic acid (EDTA), diethylenetriaminepentaacetic acid (DTPA), nitrilotriacetic acid (NTA), citric acid, tartaric acid and other like organic acids. Chelators are often added to treat or “soften” hard water. Hard water refers traditionally to water having a total concentration of calcium and magnesium ions in excess of 100 ppm expressed in units of equivalent parts per million of calcium carbonate. The molar ratio of calcium to magnesium in hard water is typically about 2:1 to about 3:1. The chelator complexes with calcium ions and prevents precipitation of calcium salts out of the water. Precipitation of calcium salts is undesirable, as they could create solid residues that deposit in the washer after the cleaning cycle.

Forming the improved chelation system of this invention is at least one organic carboxylic acid compound that is soluble in water. Some carboxylic acids are known to contain protic groups, while some do not. Without being bound by theory, it is believed that those carboxylic acids that perform well in the cleaning composition of the present invention are those that contain protic groups because the protic groups further increase water solubility. The protic group can be a hydroxyl group (—OH) or an amine group (—NH₂).

Accordingly, specific water soluble carboxylic acid compounds that are suitable for use in the cleaning composition of the present invention include tartaric acid, citric acid, glycolic acid, aspartic acid, malic acid, fumaric acid, adipic acid, and the like, and mixtures thereof. In one aspect, the carboxylic acid is present in the range from 0.01% to 10% by weight of the total cleaning composition.

The chelation system may be present in the cleaning composition in the range from 0.01% to 30% by weight of the total composition, or in the range from 0.1% to 20% by weight of the total composition, or in the range from 1% to 15% by weight of the total composition.

The organic acid used in the chelation system also improves the dissolution rate of the cleaning composition. As used herein, controlled dissolution and/or improved dissolution rate refers to the optimized rate of dissolution for the cleaning composition as it is used in conjunction with the cleaning cycle of an automatic washing machine (or other appliance). In other words, the cleaning composition of the present invention is designed to dissolve at an optimum speed with respect to the time and water temperature of the cleaning cycle of an automatic washing machine (or other appliance). The acid reacts with sodium carbonate that is released from the dissolution of the sodium percarbonate ingredient, to form a sodium salt of the acid, water and some carbon dioxide gas. The improvement in dissolution rate with the use of the organic acid is more pronounced when the cleaning composition is in the form of a tablet. The organic acid aids with the rate of disintegration of the tablet in water. The amount of acid should be sufficient to improve the chelation and increase the dissolution rate, but not too high as to compromise the stability of the cleaning composition to moisture in air.

Organic anhydrides can be used instead of, or in addition to, the organic acids in the cleaning composition. Upon contact with water, the anhydride will react with water and release the corresponding organic acid that improves chelation and dissolution rate. Anhydrides of organic acids listed above and mixture thereof can be used.

When the cleaning composition of the present invention is in the form of a tablet, it may include an improved binder system to control the dissolution rate of the cleaning tablet. Binding agents are typically included in order to aid in forming the tablet. However, the mixture of at least two binding components also surprisingly changes the dissolution rate of the cleaning tablet, as will be exemplified herein. Forming the controlled dissolution binder system of this invention is a mixture of at least one polyol binder and a second binder component. Polyols are organic compounds with two or more hydroxyl groups (—OH) attached to a carbon atom of an alkyl group (hydrocarbon chain). Polyols include polyethylene glycols (PEG), polypropylene glycols (PPG), alditols, such as sorbitol and mannitol, cyclic polyols and combinations thereof. Preferably, the polyol is sorbitol, PPG or PEG. The second binding component may be selected from the group consisting of polyols, sugars, cyclodextrins, starches, natural gums, cellulose gums, microcrystalline cellulose, methylcellulose, cellulose ethers, sodium carboxymethylcellulose, ethyl cellulose, gelatin, pectins, alginates, homopolymers and copolymers of vinyl pyrrolidone, vinyl alcohol, vinyl acetate, acrylamide, vinyl oxoazolidone, and combinations thereof. Preferably the second binding component is water soluble. Water soluble polymers include starches, natural gums, cellulose gums, microcrystalline cellulose, methylcellulose, cellulose ethers, sodium carboxymethylcellulose, ethyl cellulose, gelatin, pectins, alginates, homopolymers and copolymers of vinyl pyrrolidone, vinyl alcohol, vinyl acetate, acrylamide, vinyl oxoazolidone, and others. Most preferably the water soluble polymer is a copolymer of vinyl pyrrolidone and vinyl acetate. Water soluble sugars include monosaccharides like dextrose, fructose, maltose, and others, or polysaccharides like sucrose, lactose and others. Most preferably the sugar is dextrose. Polyols include polyethylene glycols, polypropylene glycols, and alditols, such as sorbitol, lactose, mannitol, and combinations thereof. Preferably the polyol is sorbitol.

The binder system may be present in the cleaning composition in the range from 1% to 45% by weight of the total composition, or in the range from 1% to 30% by weight of the total composition, or in the range from 1% to 20%, or in the range from 1% to 10%, or in the range from 1% to 5% by weight of the total composition. The polyol component of the binder system may be present in the range from 10% to 99.9% by weight of the total binder system, or in the range from 30% to 95% by weight of the total binder system, or in the range from 50% to 90% by weight of the total binder system.

Other ingredients may be added to the cleaning composition. For example, if the cleaning composition is intended to be formed into a tablet, lubricating agents, fillers/diluents, and binding agents may be added. Lubricating agents may be selected from the group consisting of sodium benzoate, magnesium stearate, magnesium lauryl sulfate, L-leucine, polyethylene glycol, and the like, and combinations thereof. Some of these components also offer other benefits to the cleaning composition. For instance, water insoluble lubricants (such as magnesium stearate) tend to mitigate effervescence because they form a film at the water-air interface. On the other hand, effervescence increases dissolution rate so time of dissolution can be controlled by optimizing the tablet composition. Fillers/diluents may be selected from sodium carbonate, sodium bicarbonate, potassium carbonate, potassium bicarbonate, magnesium carbonate, magnesium bicarbonate, talc, and the like, and combinations thereof.

The cleaning composition with improved chelation system and having controlled dissolution comprises a more environmentally friendly chemical profile than some prior art cleaning compositions. For example, it does not contain potentially corrosive acid components, such as boric acid. Thus, the cleaning composition of the present invention is free from boric acid.

Additionally, the cleaning composition of the present invention does not require any surfactant compounds. Thus, the cleaning composition of the present invention is free from surfactants. The term “free from surfactants” is intended to mean that the cleaning composition contains less than 5% by weight of a surfactant compound. This is relevant because surfactants are often added to cleaning composition in order to reduce the surface tension of the compositions. Accordingly, it is surprising and unexpected that the cleaning composition of the present invention exhibits high surface tension and excellent cleaning properties.

One or more optional ingredients may be added to the cleaning composition having an improved chelation system. For example, a compound which provides a desirable odor to the solid cleaning composition, such as a fragrance or perfume, may be included in the cleaning composition. A fragrance, or perfume, may be any compound known to impart a desirable odor to a composition. A fragrance may be included in the composition to leave the machine with a fresh, clean scent after removal of the odor-causing microbes and biofilm. The fragrance may be comprised of naturally occurring compounds, or it may be comprised of synthetically made compounds. Fragrances may include, merely as an example, oils, such as citric oils. The fragrance may be present in an amount between 0.001% and 20% by weight of the total composition, preferably between 0.01% and 10% by weight, and more preferably between 0.1% and 5% by weight of the total composition. It may be most preferable that the acid component is between 0.1% and 3% by weight of the total composition.

The ingredients of the cleaning composition having controlled dissolution, an improved chelation system, and improved cleaning performance may be combined together into any solid form that is desired for its intended end use application. For example, the solid cleaning composition may be formed into granulated particles of generally uniform size, or it may be formed into a solid tablet. If it is desirable that the solid cleaning composition be provided in the form of granulated particles, it may be desirable that the particle shape be greater than one-quarter of an inch in size so that the granulated particles will not fall through the holes in the bottom of the wash tub. Alternatively, if the cleaning composition is formed into a solid tablet, it may be desirable that the size of the tablet is modified to fit into any dispensers or areas of the machine in which it will be placed by the consumer for use. The tablet may have a weight in the range from about 5 grams to about 200 grams, more preferably from about 10 grams to about 100 grams, and most preferably from about 20 grams to about 50 grams.

Formation of the cleaning composition into solid form may be achieved by generally standard processes known in the art for creating granulated particles or solid tablets. If the ingredients of the composition are provided in liquid form, then they may be dehydrated by any means known to those skilled in the art for removing liquid from a composition. For instance, dehydration may be accomplished by heating the composition, such as in a hot air oven, by evaporation, by exposure to an infrared source, and the like, and combinations thereof.

After dehydration of the cleaning composition, the dry residue that remains may be combined with other ingredients, such as those described previously, and formed into the desired shape for the solid cleaning composition. Such shape manipulation may be performed by any means known for forming particles and other solid shapes. For instance, the dry ingredients may be combined together in a hydraulic press to form a solid tablet. After formation of the granulated particles or solid tablet, other additives may be added to the outside of the solid cleaning composition if desired.

One potentially preferred embodiment includes the formation of a solid cleaning tablet for use in a washing machine. In front loading washing machines, it is desirable that the solid cleaning tablet have a size and shape that allows the tablet to remain in the back of the wash tub so that the tablet does not contact the baffles that protrude inward from the wash tub. Such contact with the baffles would lead to early breaking and dissolution of the tablet and thus, less than optimal cleaning of the machine. The tablet should also be of a small enough size and weight that it does not set off the weight sensors that are built into the cleaning cycle of the washing machine. The cleaning cycle is designed to sense whether there are clothes in the machine at the beginning of the cycle. If there is a tablet in the wash tub that is too large, the weight sensors will detect it and send a signal to the machine that a normal wash cycle should occur rather than the cleaning cycle. Such a situation would result in wasted cleaning products, water, and energy. Ideally, the solid cleaning composition should dissolve completely in either hot water or cold water and should contain ingredients which are not detrimental to the machine or the clothing that will be put into the machine after a cleaning cycle has been performed.

While it is may be desirable that the cleaning composition of the present invention is formed into a solid tablet for ease of use, it is also contemplated to be within the scope of this invention that the cleaning composition is provided in any form that is capable of delivering the composition to the device which is to be cleaned. For instance, the solid cleaning composition may be in the form of a powder that is placed within a sachet or pouch. The solid cleaning composition may be present as a textile sheet coated with the composition. The solid cleaning composition may be present as a powder that is encapsulated within a water soluble film.

The present invention further relates to a non-oxidizing (as defined in class 5 division 5.1 solid oxidizer test) cleaning composition that contains peroxide moieties and the method for making the cleaning composition. Peroxides have a bleaching effect on organic substances and therefore are often added to some detergents in the form of an oxidizing agent. Sodium percarbonate is a commonly used such oxidizing ingredient in home and laundry cleaning products. When dissolved in water, sodium percarbonate decomposes to hydrogen peroxide and sodium carbonate. However, sodium percarbonate (and compositions containing sodium percarbonate) is known to have poor storage stability and additive(s) have typically been added to coat the sodium percarbonate and reduce its sensitivity to moisture. These additives include metaboric acid, boric acid and borates (U.S. Pat. No. 5,658,873; EP0567140), alkali metal or alkali earth metal silicate, carbonate, sulfate, nitrate and chloride (U.S. Pat. Nos. 4,325,933; 5,851,420; 5,462,804; EP 0634482), as well as mono and dicarboxylic acids (EP0407189).

While these coating additives improve storage stability, sodium percarbonate is still a class 5 division 5.1 solid oxidizer. Thus, exposure to moisture and/or certain temperatures may trigger self-accelerating decomposition of the sodium percarbonate, which may cause the undesirable release of heat and oxygen.

Binding systems have also been used to improve the storage stability of solid cleaning compositions containing sodium percarbonate. Man et al. (US 20030109403 A1, US 20030162685 A1) disclosed the use of organic sequestrants such as phosphonates aminocarboxylates to stabilize solid or agglomerated cleaning compositions containing peroxygen moieties such as sodium percarbonate, All the disclosed detergent cleaning formulations contained phosphorus based ingredients and relatively low peroxygen ingredient content.

Therefore, there is still a need for a solid cleaning composition containing a majority component of peroxide moieties and a binding system that is a non-oxidizer according to class 5 division 5.1 classification.

Thus, the present invention further includes a solid cleaning composition in a tablet form containing a majority by weight of a peroxygen ingredient that is a non-oxidizing Class 5 Division 5.1 solid. At least some of the embodiments include a novel binding system in the composition that contains peroxide moieties. The binding system contains at least one flame retardant. In addition, the novel solid cleaning formulation leaves no solid residue when used in a cleanout cycle of a high efficiency washer (the tub of the washing machine or other appliance is substantially residue-free after the cleaning cycle).

It has been unexpectedly discovered that by pressing the disclosed ingredients comprising the cleaning formulation together into a tablet form and then grinding it into particulate ingredients for solid oxidizer testing, the oxidizing property of the cleaning composition is decreased substantially, and in some aspects eliminated entirely.

The non-oxidizing cleaning composition that contains a peroxide generating ingredient is comprised of a majority by weight of an oxidizing agent. As described herein, oxidizing agents include those materials that decompose in water and release hydrogen peroxide. Suitable oxidizing agents include percarbonate, perborate, persulfate, perphosphate, persilicate, and mixtures thereof.

The cleaning composition also includes one or more of the following ingredients: flame retardants, binders, diluents, chelating agents, lubricants, surfactants, defoamers, fragrances, colorants, alkalinity sources, softening agents, buffering agents, anti-corrosion agents, bleach activators, anti-redeposition agents, antimicrobials, rinse aids, enzymes, other ingredients and the like, and mixtures thereof. Each of these ingredients may be independently present in the cleaning composition in an amount that is in the range from 0.01% to 20% by total weight of the composition, or in the range from 0.1% to 10% by total weight of the composition, or in the range from 0.5% to 5% by total weight of the composition.

Suitable flame retardants include alkali and alkali earth metal hydroxides, carbonates and sulfates, aluminum hydroxide, hydroxide and carbonate minerals containing aluminum and calcium or magnesium, and combinations thereof. Preferably, the flame retardants are soluble in water. Most preferably the flame retardants are alkali and alkali earth metal sulfates and preferably, magnesium sulfate and sodium sulfate. The combination of sodium sulfate and magnesium sulfate also improves the dissolution rate of the cleaning composition so that no solid residues remain at the end of the cleaning cycle. As used herein, improved dissolution rate refers to the optimized rate of dissolution for the cleaning composition as it is used in conjunction with the cleaning cycle of an automatic washing machine (or other appliance). In other words, the cleaning composition of the present invention is designed to dissolve at an optimum speed with respect to the time and water temperature of the cleaning cycle of an automatic washing machine (or other appliance). The improvement in dissolution rate with the use of the combination of sodium sulfate and magnesium sulfate flame retardants is more pronounced when the cleaning composition is in the form of a tablet. In one aspect, the flame retardant is present in the range from 5% to 40% by weight of the total cleaning composition.

Forming the controlled dissolution binder system of this invention is a mixture of at least one polyol binder and a second binder component. Polyols are organic compounds with two or more hydroxyl groups (—OH) attached to a carbon atom of an alkyl group (hydrocarbon chain). Polyols include polyethylene glycols (PEG), polypropylene glycols (PPG), alditols, such as sorbitol and mannitol, cyclic polyols and combinations thereof. Preferably, the polyol is sorbitol, PPG or PEG. The second binding component may be selected from the group consisting of polyols, sugars, cyclodextrins, starches, natural gums, cellulose gums, microcrystalline cellulose, methylcellulose, cellulose ethers, sodium carboxymethylcellulose, ethyl cellulose, gelatin, pectins, alginates, homopolymers and copolymers of vinyl pyrrolidone, vinyl alcohol, vinyl acetate, acrylamide, vinyl oxoazolidone, and combinations thereof. Preferably the second binding component is water soluble. Water soluble polymers include starches, natural gums, cellulose gums, microcrystalline cellulose, methylcellulose, cellulose ethers, sodium carboxymethylcellulose, ethyl cellulose, gelatin, pectins, alginates, homopolymers and copolymers of vinyl pyrrolidone, vinyl alcohol, vinyl acetate, acrylamide, vinyl oxoazolidone, and others. Most preferably the water soluble polymer is a copolymer of vinyl pyrrolidone and vinyl acetate. Water soluble sugars include monosaccharides like dextrose, fructose, maltose, and others, or polysaccharides like sucrose, lactose and others. Most preferably the sugar is dextrose. Polyols include polyethylene glycols, polypropylene glycols, and alditols, such as sorbitol, lactose, mannitol, and combinations thereof. Preferably the polyol is sorbitol.

Suitable chelators include ethylenediaminetriacetic acid (EDTA), diethylenetriaminepentaacetic acid (DTPA), nitrilotriacetic acid (NTA), tartaric acid, citric acid, glycolic acid, aspartic acid, malic acid, fumaric acid, adipic acid, and other like organic acids, and combinations thereof. Anhydrides of organic acids listed above and mixture thereof can be used instead of, or in addition to, the organic acids in the cleaning composition. Upon contact with water, the anhydride will react with water and release the corresponding organic acid.

When the chelating agent is an organic acid (or corresponding anhydride), it also improves the dissolution rate of the cleaning composition. As used herein, controlled dissolution and/or improved dissolution rate refers to the optimized rate of dissolution for the cleaning composition as it is used for example in conjunction with the cleaning cycle of an automatic washing machine (or other appliance). In other words, the cleaning composition of the present invention is designed to dissolve at an optimum speed with respect to the time and water temperature of the cleaning cycle of an automatic washing machine (or other appliance) so as to leave no solid residue at the end of the cleaning cycle. The acid reacts with sodium carbonate that is released from the dissolution of the sodium percarbonate ingredient, to form a sodium salt of the acid, water and some carbon dioxide gas. The improvement in dissolution rate with the use of the organic acid is more pronounced when the cleaning composition is in the form of a tablet. The organic acid aids with the rate of disintegration of the tablet in water. The amount of acid should be sufficient to improve the chelation and increase the dissolution rate, but not too high as to compromise the stability of the cleaning composition to moisture in air.

Suitable diluents/fillers include sodium carbonate, sodium bicarbonate, potassium carbonate, potassium bicarbonate, magnesium carbonate, magnesium bicarbonate, talc, and the like, sodium sulfate, sodium chloride, starch, sugars, polyalkylene glycols and the like, and combinations thereof.

Suitable lubricants include sodium benzoate, magnesium stearate, magnesium lauryl sulfate, L-leucine, polyethylene glycol, and the like, and combinations thereof. Some of these components also offer other benefits to the cleaning composition. For instance, water insoluble lubricants (such as magnesium stearate) tend to mitigate effervescence because they form a film at the water-air interface.

Additional alkalinity sources besides peroxide containing ingredients can be used to enhance cleaning performance. Suitable alkalinity ingredients include alkali metal salts, such as carbonates, alkali metal hydroxides or silicates, or the like. Examples include sodium or potassium hydroxide, sodium or potassium silicate or metasilicate or metasilicate pentahydrate. Other sources of alkalinity include ethanolamines and amines and the like.

Suitable fragrances include citrus and other fragrances commonly used in cleaning products. In addition, a fragrance component may be added to eliminate any unpleasant odor contained within an appliance. Examples of commercially available fragrances are DeoEssence® and DeoActive® fragrances from Arrylessence.

The cleaning composition may also include one or more of the following ingredients: surfactants, defoamers, colorants, softening agents, buffering agents, anti-corrosion agents, bleach activators, anti-redeposition agents, antimicrobials, rinse aids, enzymes, and mixtures thereof.

The cleaning composition may be provided in the form of pellets, granules, powder, tablets, and the like. Standard tableting equipment may utilized to form tablets such as, for example, a Carver press. The tablets may be of any size, preferably in the range from 1 gram to 100 grams, or in the range from 2 grams to 60 grams, or in the range from 5 grams to 30 grams. The tablets may be of any shape, including round, oval, square, rectangular, and the like.

The cleaning composition, when in tablet form, should possess a dissolution rate that is customized for its end-use application. For instance, a cleaning tablet of the present invention should dissolve such that there is no solid residue left at the end of the cleaning cycle in an automatic washing machine. In this regard, the tablet may be considered to dissolve completely.

The following examples further illustrate the subject matter described above but, of course, should not be construed as in any way limiting the scope thereof.

Cleaning Compositions

The cleaning compositions were made by dry blending the various ingredients in a tumble blender or by using a kitchen aid style mixer at ambient temperature. When preparing formulations containing effervescence ingredients (e.g. citric acid), the relative humidity of the mixing environment was controlled to as low a level as practically possible.

The resultant mixed powder was then placed into a machined stainless mold (i.e. a mold used to form tablets) available from Carver, Inc. of Wabash, Ind. The tablets were formed at compression pressures ranging from 5,000 psig to 15,000 psig.

### Example 1

| Ingredients | Amount (Percent by Weight) |
|---|---|
| Sodium Percarbonate | 60 |
| L-Tartaric Acid | 10 |
| Sorbitol | 27.5 |
| Sodium Benzoate | 2 |
| Fragrance | 0.5 |

### Comparative Example 1

Commercially available Affresh® washing machine cleaning tablet.

Test Methods and Evaluation

Dissolution Test in Automatic Washing Machine with Cleanout Cycle:

Cleaning tablets were evaluated for dissolution in a typical cleanout cycle of an automatic washing machine. The cleanout cycle included 6 minutes preparation time, 20 minute cleaning time, and 20 minutes for rinsing.

Comparative Example 1 dissolved 80-90% after 35 minutes into the cycle. The tablet was still present in some compacted form during the rinse cycle. There was some tablet residue on the inside of the washing machine tub at the end of the cleanout cycle. Example 1 dissolved completely before the start of the rinse cycle.

Dissolution Test in Cold Water:

Cleaning tablets were evaluated for cold water dissolution. The tablet was dropped into a container containing 9.9 liters of tap water that has been cooled by adding 8.8 kg of ice into the water. The temperature of the water was 1° C. to 2° C. The water was stirred with an overhead stirrer at 25 rpm. The time elapsed for complete dissolution of the tablet was recorded. Comparative Example 1 dissolved in 1000 minutes. Example 1 dissolved in 34 minutes.

Dissolution Test in Hard Water:

This test utilized the following water hardness scale (mg/liter/equivalent CaCO₃):
Soft water, 0-60
Moderately hard water, 61-120
Hard water, 121-180
Very hard water, ≥181.

1.2 grams of cleaning granular formulation was added to 300 grams of water, and mixed until it completely dissolved. If the cleaning composition was in the form of a tablet, the latter was ground into a powder with a mortar and pestle. Then 0.83 grams of 6.02% MgSO₄ aqueous solution and 0.68 grams of 4.23% CaCl₂) aqueous solution were added to the solution (in that order) to yield a water hardness of 100 ppm of equivalent milligrams of CaCO₃ per liter of solution. For water hardness of 200 ppm, 1.65 grams of 6.02% MgSO₄ aqueous solution and 1.35 grams of 4.23% CaCl₂) aqueous solution were added, respectively. Each solution was visually evaluated. “Clear” indicates that alphanumeric characters (e.g. letters) written on white paper placed under the beaker containing the solution could be read clearly without change in appearance. “Slightly hazy” indicates that letters written on white paper placed under the beaker containing the solution could be read but their appearance was not sharp. “Hazy” indicates that letters written on white paper placed under the beaker containing the solution could not be read easily and appeared blurry. The turbidity of each solution was also measured with a HANNA C124 Haze Meter Logger instrument. The turbidity is reported in EBC (European Brewery Commission) units.

The results are shown in Table 1.

TABLE 1
Hard Water Dissolution

| Water Hardness | Appearance of Solution | | Turbidity (in EBC) | |
|---|---|---|---|---|
| (mg/liter eq | Comparative | | Comparative | |
| CaCO₃) | Example 1 | Example 1 | Example 1 | Example 1 |
| 0 | Clear | Clear | 0.07 | 0.00 |
| 100 | Slightly Hazy | Clear | 18 | 1.97 |
| 200 | Hazy | Clear | 70 | 7.54 |

The test results illustrate that the cleaning composition of Example 1 dissolved better in hard water than the Affresh® cleaning product.

Cleaning Performance Test:

The cleaning performance of several cleaning compositions was evaluated in an automatic washing machine. The machine was a Whirlpool Duet, model no. WFW9400ST00. The Tide® detergent was Tide® Free & Gentle Detergent (HE version). The Tide® wash cleaner was Tide® Washing Machine Cleaner product.

Cleanliness percentage was calculated from the ratio of clean area to total area of wash tub as determined by visual observation and photographs of the interior surface of the wash tub.

The results are provided in Table 2.

TABLE 2
Cleaning Performance

| Treatment | Cleanliness of Washer |
|---|---|
| Fouled Washer | 0% |
| (Control) | |
| Washing cycle cleaned with | 4% |
| Tide ® detergent | |
| Cleanout cycle with water | 44% |
| Tide ® washer cleaner | 63%-72% |
| Cleanout cycle with | 90% |
| Comparative Example 1 | |
| Cleanout cycle with | 97%-100% |
| Example 1 | |

### Examples 2-5

Examples 2 to 5 show the effect of the binder system on the dissolution rate of the cleaning tablet in cold water. Formulations of composition shown below were prepared by mixing the different powder components thoroughly in a bag. Tablets of 1.5″ in diameter and −40 grams in weight were pressed at 8,500 psig by placing them into a machined stainless mold (i.e. a mold used to form tablets) available from Carver, Inc. of Wabash, Ind. The tablet was dropped into a container containing 9.9 kg of tap water that has been cooled by adding 8.8 kg of ice into the water. The temperature of the water was 1° C. to 2° C. The water was stirred with an overhead stirrer at 25 rpm. After 5 minutes and 10 minutes, the tablet is removed from the cold water and weighed. The tablet weights at time 0, 5 and 10 minutes are shown in Table 3.

Cleaning Formulations

| | Amount (Percent by Weight) | | | |
|---|---|---|---|---|
| Ingredients | Example 2 | Example 3 | Example 4 | Example 5 |
| Sodium Percarbonate | 60 | 60 | 60 | 60 |
| L-Tartaric Acid | 10 | 10 | 0 | 0 |
| Citric Acid | 0 | 0 | 10 | 10 |
| Sorbitol | 28 | 0 | 28 | 0 |
| Dextrose | 0 | 28 | 0 | 28 |
| Sodium Benzoate | 2 | 2 | 2 | 2 |

TABLE 3
Dissolution time of cleaning tablets in cold water

| | Weight of tablet at | Weight of tablet at | Weight of tablet at |
|---|---|---|---|
| Sample | 0 minutes | 5 minutes | 10 minutes |
| Example 2 | 39.9 | 14.6 | 2.3 |
| Example 3 | 39.9 | 0 | — |
| Example 4 | 40 | 18.9 | 5.9 |
| Example 5 | 39.9 | 0 | — |

The test results illustrate that tablets made with dextrose binder dissolved more than twice as fast as the tablets made with sorbitol binder. This is surprising as the solubility of dextrose in water at 25° C. is 91 grams per 100 ml, while the solubility of sorbitol is 220 grams per 100 ml.

### Examples 6-10

Examples 6 to 10 further exemplify how the disclosed binder system can control the dissolution rate in cold water. Formulations of composition shown in Table 4 were prepared by mixing the different powder components thoroughly in a bag. The concentration of the binder system was kept constant at 27.5 weight percent. Tablets of 1.5″ in diameter and about 40 grams in weight were pressed at 8,500 psig by placing them into a machined stainless mold (i.e. a mold used to form tablets) available from Carver, Inc. of Wabash, Ind. The tablet was dropped into a container containing 9.9 kg of tap water that has been cooled by adding 8.8 kg of ice into the water. The temperature of the water was 1° C. to 2° C. The water was stirred with an overhead stirrer at 25 rpm. After 5 minute intervals, the tablet was removed from the cold water and weighed. The tablet weights at time 0, 5, 10, 15, 20, 25 and 30 minutes are shown in Table 5.

TABLE 4
Composition of the cleaning formulations

| | Amount (Percent by Weight) | | | | |
|---|---|---|---|---|---|
| | Example | Example | Example | Example | Example |
| Ingredients | 6 | 7 | 8 | 9 | 10 |
| Sodium | 60.00 | 60.00 | 60.00 | 60.00 | 60.00 |
| Percarbonate | | | | | |
| L-Tartaric Acid | 10.00 | 10.00 | 10.00 | 10.00 | 10.00 |
| Fragrance | 0.50 | 0.50 | 0.50 | 0.50 | 0.50 |
| Sorbitol | 0.00 | 6.88 | 13.75 | 20.62 | 27.50 |
| Dextrose | 27.50 | 20.62 | 13.75 | 6.88 | 0.00 |
| Sodium Benzoate | 2.00 | 2.00 | 2.00 | 2.00 | 2.00 |

TABLE 5
Dissolution time of cleaning tablets in cold water

| Weight of tablet (grams) | Time (minutes) | | | | | | |
|---|---|---|---|---|---|---|---|
| Example | 0 | 5 | 10 | 15 | 20 | 25 | 30 |
| 6 | 40.3 | 7.7 | 0 | 0 | 0 | 0 | 0 |
| 7 | 40.0 | 9.3 | 0 | 0 | 0 | 0 | 0 |
| 8 | 41.3 | 16.1 | 2.7 | 0 | 0 | 0 | 0 |
| 9 | 39.8 | 28.7 | 18.8 | 11.2 | 6.0 | 2.5 | 0 |
| 10 | 39.8 | 28.2 | 19.1 | 12.5 | 7.7 | 4.2 | 2.2 |

The test results show that the dissolution time of the tablet in cold water increases as the sorbitol to dextrose ratio in the binder system increases.

### Examples 11-14

Examples 11 and 12 show the effect of the binder system on the dissolution effectiveness of the cleaning composition in hard water. The preparation method and hard water dissolution test protocol were the same as described in Example 1.

| | Amount (Percent by Weight) | | | |
|---|---|---|---|---|
| | Example | Example | Example | Example |
| Ingredients | 11 | 12 | 13 | 14 |
| Sodium | 60 | 60 | 60 | 60 |
| Percarbonate | | | | |
| Citric Acid | 10 | 10 | 0 | 0 |
| D,L-Tartaric Acid | 0 | 0 | 10 | 10 |
| Sorbitol | 30 | 0 | 27.5 | 0 |
| Dextrose | 0 | 30 | 0 | 27.5 |
| Fragrance | 0 | 0 | 0.5 | 0.5 |
| Sodium Benzoate | 0 | 0 | 2 | 2 |

Test results are shown in Tables 6a and 6b.

TABLE 6a
Hard Water Dissolution of Examples 11 and 12.

| Water Hardness | | |
|---|---|---|
| (mg/liter eq | Turbidity (in EBC) | |
| CaCO₃) | Example 11 | Example 12 |
| 200 | 3.4 | 0.6 |
| 300 | 7.0 | 2.4 |
| 400 | 17.0 | 6.2 |

TABLE 6b
Hard Water Dissolution of Examples 13 and 14.

| Water Hardness | | |
|---|---|---|
| (mg/liter eq | Turbidity (in EBC) | |
| CaCO₃) | Example 13 | Example 14 |
| 400 | 11.5 | 7.6 |

The test results show that Examples 12 and 14 made a clearer solution (i.e. less hazy or less cloudy) than Examples 11 and 13, respectively. The cleaning composition with a binder system that contained dextrose dissolved better in hard water than the composition with a binder system that contained sorbitol.

Thus, cleaning composition with improved chelation system and controlled dissolution system offers significant improvements over the prior art cleaning compositions. The inventive cleaning composition provides improved cleaning performance, improved hard water performance, a more environmentally friendly chemical profile, and improved washer compatibility (less wear). The cleaning composition with improved chelation system and controlled dissolution system has been designed to work with automatic washing machine cycle conditions (time, temperature, water volume, etc.) and to reduce or eliminate both the biological and the abiotic buildup.

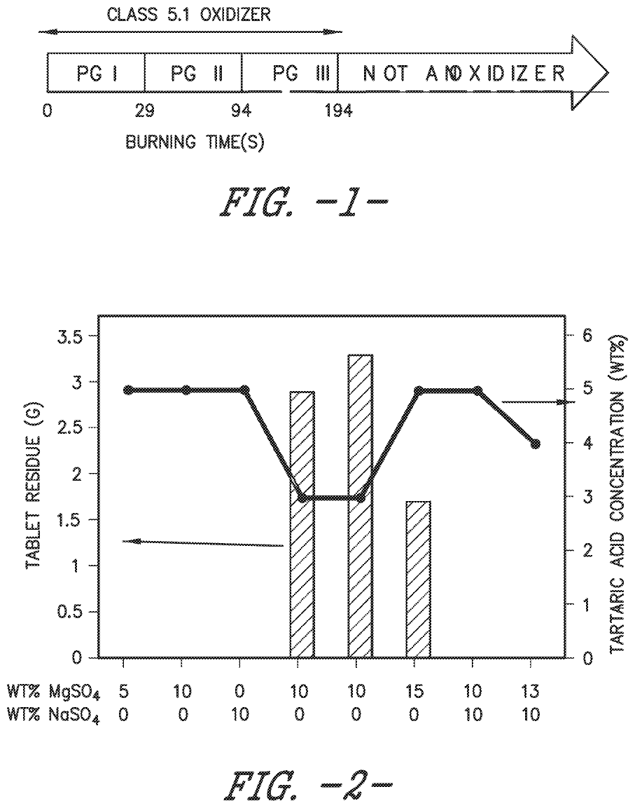

The composition of the formulations that were tested in the Class 5 Div. 5.1 Solid Oxidizer DOT test are shown in Table 7. The measured burning times in the test are listed in Table 8 along with the Packing Group (“PG”) Classification. The relationship between burn times and the oxidizer test Packing Groups is represented in FIG. 1.

TABLE 7
Composition of Cleaning Tablet Formulations

| Ingredient | Weight % |
|---|---|
| Sodium Percarbonate | 60.0 |
| Sodium Carbonate | 4.0 (*) |
| DL-Tartaric Acid | 5.0 (*) |
| Sodium Metasilicate Pentahydrate | 5.0 |
| Vinylpyrrolidone-vinyl acetate copolymer | 2.0 |
| Sodium Benzoate | 2.0 (*) |
| Polypropylene Glycol 425 | 1.0 |
| Methyl Oxirane Polymer with Oxirane | 0.5 |
| Citrus Fragrance | 0.5 |
| Sodium Sulfate | See |
| | Table 8 |
| Magnesium Sulfate | See |
| | Table 8 |

Physical mixture samples were produced by mixing the ingredients in a beaker and/or in a plastic bag. Pressed and ground samples were produced by pressing the former physical mixture into a 1.5″ diameter cylindrical tablet at 10,000 psi and subsequently grinding the formed tablet with a mortar and pestle.

TABLE 8
Burn times and Class 5 Division 5.1 Packing Group
Classification of Formulations described in Table 7.

| | | | | Burn | |
|---|---|---|---|---|---|
| | MgSO₄ | Na₂SO₄ | | Time | Packing |
| Sample | (%) | (%) | Process | (seconds) | Group |
| Example 15 | 0 | 0 | Pressed & Ground | 58 | II |
| Example 16 | 5 | 0 | Physical Mixture | 200 | Not |
| | | | | | Oxidizer |
| Example 17 | 10 | 0 | Physical Mixture | 215 | Not |
| | | | | | Oxidizer |
| Example 18 | 0 | 10 | Physical Mixture | 200 | Not |
| | | | | | Oxidizer |
| Example 19 | 5 | 5 | Physical Mixture | 393 | Not |
| | | | | | Oxidizer |
| Example 20 | 5 | 5 | Pressed & Ground | 150 | III |
| Example 21 | 5 | 5 | Pressed & Ground, | 162 | III |
| | | | aged | | |
| Example 22 | 10 | 5 | Pressed & Ground | 134 | III |
| Example 23 | 10 | 10 | Pressed & Ground | 179 | III |
| Example 24* | 13 | 10 | Pressed & Ground | 277 | Not |
| | | | | | Oxidizer |

(*)In Example 24, Sodium Carbonate was 1 wt %;
DL Tartaric Acid was 4 wt % and Sodium Benzoate was 1 wt %.

Results in Table 8 for Examples 19 and 20 show that the sample made by pressing the physical mixture of ingredients into a tablet and then grinding it back into a powder is a Class 5 Division 5.1 Packing Group III oxidizer while the physical mixture of ingredients of the same formulation is not an oxidizer. This unexpected result demonstrates that the process of tableting and grinding has a significant effect on the outcome of the oxidizer test.

A physical mixture of ingredients with as low as 5 wt % MgSO₄ is not an oxidizer; on the other hand the amounts of MgSO₄ and Na₂SO₄ in the pressed and ground formulation must be raised to a total of 23 wt % in order to make the material a non-oxidizer, along with reducing both the tartaric acid and the sodium benzoate by 1 wt %.

Aging the pressed tablet for several days before grinding it and testing its oxidizing properties did not affect the test outcome.

Another important property of the cleaning formulation in a tablet form is the absence of solid residues at the end of the cleaning cycle of the washer. The washer cleaning cycle was run with 40 gram tablets of the formulations specified in Table 9 and FIG. 2. The weight of tablet residues, if any, after the cleaning cycle was measured and is plotted in FIG. 2 as a function of weight percent of MgSO₄, Na₂SO₄ and tartaric acid in the tablet.

TABLE 9
Composition of Cleaning Tablet Formulations tested for
complete dissolution in washer cleaning cycle.

| Ingredient | Weight % |
|---|---|
| Sodium Percarbonate | 60.0 |
| Sodium Carbonate | Remainder so |
| | Total = 100% |
| DL-Tartaric Acid | See FIG. 2 |
| Sodium Metasilicate Pentahydrate | 5.0 |
| Vinylpyrrolidone-vinyl acetate copolymer | 2.0 |
| Sodium Benzoate | 2.0 |
| Polypropylene Glycol 425 | 1.0 |
| Methyl Oxirane Polymer with Oxirane | 0.5 |
| Citrus Fragrance | 0.5 |
| Sodium Sulfate | See FIG. 2 |
| Magnesium Sulfate | See FIG. 2 |

FIG. 2 illustrates the weight of tablet residue after the washer cleanout cycle as a function of concentrations of tartaric acid, Na₂SO₄ and MgSO₄.

FIG. 2 shows that tablet residues are observed when the concentration of tartaric acid decreases to 3 wt % and the concentration of MgSO₄ equal to 10 wt %. When the latter increases to 15%, increasing the concentration of tartaric acid to 5 wt % still leads in tablet residues. Optimal concentrations of MgSO₄ and Na₂SO₄ equal to 13 wt % and 10 wt %, respectively, coupled with a concentration of tartaric acid equal to 4 wt % lead to a tablet formulation that leaves no solid residue after the washer cleaning cycle and is a not a solid oxidizer, concurrently.

In addition, since is Na₂SO₄ more soluble in water than MgSO₄, a tablet containing a combination of 10 wt % Na₂SO₄ and 10 wt % leaves no residue while a tablet containing 15 wt % MgSO₄ alone leaves 1.7 grams of tablet residue at the same 5 wt % tartaric acid concentration. The presence of Na₂SO₄ may also facilitate the dissolution of MgSO₄.

Combination of flame retardant additives at disclosed concentrations that when used in washer cleaner formulation containing a majority by weight of a percarbonate-based compound produces a compacted or pressed form that is not a solid oxidizer.

In addition, the combination of the said flame retardant additive composition with an amount of tartaric acid greater than 3 wt % in the washer cleaning tablet so that no solid residue is observed after the washer cleaning cycle.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A method for cleaning an automatic washing machine comprising the sequential steps of:
(a) providing an automatic washing machine having a wash tub;
(b) adding a sufficient amount of a cleaning composition to the wash tub, wherein the cleaning composition comprises:
i. a majority by weight of a percarbonate-based compound;
ii. a chelation system, wherein the chelation system is comprised of at least one carboxylic acid compound; and
iii. a binding system, wherein the binding system is comprised of at least one polyol and a second binder component;
(c) adding a sufficient amount of water to the wash tub to allow the cleaning composition to dissolve and form a mixture of water and cleaning composition;
(d) agitating the mixture of step “c”;
(e) removing the mixture of step “c” from the wash tub; and
(f) rinsing the wash tub.

2. The method of claim 1, wherein the composition is in a compacted or pressed form and is not a solid oxidizer.

3. The method of claim 1, wherein the percarbonate-based compound is present in the range from 50% to 70% by weight of the total cleaning composition.

4. The method of claim 1, wherein the percarbonate-based compound is sodium percarbonate.

5. The method of claim 1, wherein the second binder component is selected from the group consisting of polyols, sugars, cyclodextrins, starches, natural gums, cellulose gums, microcrystalline cellulose, methylcellulose, cellulose ethers, sodium carboxymethylcellulose, ethyl cellulose, gelatin, pectins, alginates, homopolymers and copolymers of vinyl pyrrolidone, vinyl alcohol, vinyl acetate, acrylamide, vinyl oxoazolidone, and combinations thereof.

6. The method of claim 5, wherein the second binder component is a sugar.

7. The method of claim 5, wherein the second binder component is a copolymer of vinyl pyrrolidone and vinyl acetate.

8. The method of claim 5, wherein polyols are selected from the group consisting of polyethylene glycols, polypropylene glycols, alditols, and combinations thereof.

9. The method of claim 5, wherein sugars are selected from the group consisting of monosaccharides and polysaccharides.

10. The method of claim 1, wherein the composition further includes a lubricating agent.

11. The method of claim 10, wherein the lubricating agent is selected from the group consisting of sodium benzoate, magnesium stearate, magnesium lauryl sulfate, L-leucine, polyethylene glycol, and combinations thereof.

12. The method of claim 1, wherein the composition further includes a fragrance.

13. The method of claim 1, wherein the composition further includes fillers.

14. The method of claim 13, wherein fillers are selected from the group consisting of sodium carbonate, sodium bicarbonate, potassium carbonate, potassium bicarbonate, magnesium carbonate, magnesium bicarbonate, and mixtures thereof.

15. The method of claim 1, wherein the composition further includes a chelating system.

16. The method of claim 15, wherein the chelating system includes ethylenediaminetriacetic acid, diethylenetriaminepentaacetic acid, nitrilotriacetic acid, tartaric acid, citric acid, glycolic acid, aspartic acid, malic acid, fumaric acid, adipic acid, anhydrides of organic acids, and mixtures thereof.

17. The method of claim 1, wherein the composition further includes at least one additional source of alkalinity.

18. The method of claim 17, wherein the at least one additional source of alkalinity is selected from the group consisting of alkali metal salts, alkali metal hydroxides or silicates, and mixtures thereof.

19. The method of claim 17, wherein the at least one additional source of alkalinity is selected from the group consisting of sodium or potassium hydroxide, sodium or potassium silicate or metasilicate or metasilicate pentahydrate, ethanolamines and amines, and mixtures thereof.

20. The method of claim 1, wherein the composition further includes a defoaming agent.

21. The method of claim 20, wherein the defoaming agent is a methyl oxirane polymer.

22. The method of claim 20, wherein the defoaming agent is selected from random, block and reverse block copolymers of ethylene oxide and propylene oxide, and mixtures thereof.

23. The method of claim 1, wherein the composition is in the form of a tablet.

24. The method of claim 23, wherein the tablet is in the weight range of 5 grams to 200 grams.

25. A method for cleaning an automatic washing machine comprising the sequential steps of:
(a) providing an automatic washing machine having a wash tub;
(b) adding a sufficient amount of a cleaning composition to the wash tub, wherein the cleaning composition comprises:
i. a majority by weight of a percarbonate-based compound;
ii. a binder system, wherein the binder system is comprised of at least one polyol and a second binder component;
iii. a flame retardant system; and
iv. a carboxylic acid compound;
(c) adding a sufficient amount of water to the wash tub to allow the cleaning composition to dissolve and form a mixture of water and cleaning composition;
(d) agitating the mixture of step “c”;
(e) removing the mixture of step “c” from the wash tub; and
(f) rinsing the wash tub.

26. The method of claim 25, wherein the flame retardant system is present in the range from 5% to 40% by weight of the total cleaning composition.

27. The method of claim 25, wherein the carboxylic acid is present in the range from 0.01% to 10% by weight of the total cleaning composition.

28. The method of claim 25, wherein the flame retardant system is selected from alkali and alkali earth metal hydroxides, carbonates and sulfates, aluminum hydroxide, hydroxide and carbonate minerals containing aluminum and calcium or magnesium, and combinations thereof.

29. The method of claim 28, wherein the flame retardant system is selected from a combination of an alkali earth metal sulfate and an alkali metal sulfate.

30. The method of claim 28, wherein the flame retardant system is selected from a combination of magnesium sulfate and sodium sulfate.

31. The method of claim 25, wherein the carboxylic acid compound is selected from the group consisting of tartaric acid, citric acid, glycolic acid, aspartic acid, malic acid, fumaric acid, adipic acid, and combinations thereof.

32. The method of claim 31, wherein the carboxylic acid compound is tartaric acid.

33. The method of claim 31, wherein the carboxylic acid compound is citric acid.
